(19) United States
(12) Patent Application Publication
(10) Pub. No.: US 2003/0130939 A1
(43) Pub. Date: Jul. 10, 2003

(54) Wealth transfer plan using in kind loan repayment with term insurance protection

(75) Inventors: Michael D. Brown, Irvine, CA (US); Jonathan G. Blattmachr, Garden City, NY (US)

Correspondence Address: Bernard L. Kleinke, Foley & Lardner, 23rd Floor, 402 West Broadway, San Diego, CA, 92101-3542, US

(73) Assignee: Spectrum Group Investments, LLC

(21) Appl. No.: 10/043,991

(22) Filed: Jan. 9, 2002

(51) Int. Cl. G06F 17/60

(52) U.S. Cl. 705/39

(57) ABSTRACT

A system and method for the efficient transfer of wealth is disclosed. The system and method implement a plan for the efficient transfer of wealth. The disclosed embodiments include a company computer for gathering information on the amount of wealth to be transferred from a transferor. An amount is determined to be transferred from the transferor to a transferee in the form of a loan. According to the plan, an insurance policy having a term benefit is purchased by the transferee, and the term benefit is assigned to the transferor as an economic benefit which is credited towards the loan. The economic benefit may be determined according to, for example, published IRS Table PS58. The economic benefit may be significantly greater than the actual cost of the policy, with the spread being effectively transferred to the transferee.

### FIELD OF THE INVENTION

The present invention relates in general to a method and apparatus for transferring wealth. It more particularly relates to a method and apparatus for transferring wealth in an effective manner while reducing the tax consequences of the transaction.

### BACKGROUND ART

There have been many different types and kind of systems for implementing financial plans. For example, reference may be made to the following U.S. Pat. Nos. 3,634,669; 4,648,037; 5,191,522; 5,214,579; 5,231,571; 5,233,514; 5,429,506; 5,631,828; 5,761,441; 5,819,230; 5,933,815; 5,966,693; 5,999,917; 6,018,714; 6,064,969; 6,161,096.

Many of these financial plans relate to mortgages and insurance plans. However, they are not specifically related to the transfer of wealth from one person to another.

It has been found to be desirable to effectively transfer wealth to others, such as grandchildren or other family members in a cost-effective manner. There have been various estate planning techniques employed in the past. For example, generation-skipping trusts have been employed to be an effective tool in conveying one's wealth to members of one's family.

There can be undesirable costs incurred in connection with the funding of such a trust. Such costs can include the cost of liquidating assets at an undesirable time to fund the transfer. This is especially undesirable where very large sums of money or assets are to be transferred. Also, the funding of the trust can cause the unwanted imposition of taxes such as estate taxes or gift taxes which could otherwise diminish the effective amount of the funding. An outright transfer to another, such as a family member, can also, of course, trigger estate or gift taxes which would likewise diminish the amount of the transfer of wealth.

Thus, the disclosed embodiment of the present invention helps in the effective transfer of wealth, while minimizing or reducing the costs associated with the transfer.

### DESCRIPTION OF THE DRAWINGS

FIG. 1 is a diagrammatic view of a plan for transferring wealth according to one embodiment of the invention;

FIG. 2 illustrates a method according to an embodiment of the invention for implementing the plan for transferring wealth of FIG. 1; and

FIG. 3 is a block diagram of a system according to one embodiment of the invention for implementing and administering the wealth transfer plan illustrated in FIG. 1.

### DETAILED DESCRIPTION OF PREFERRED EMBODIMENTS

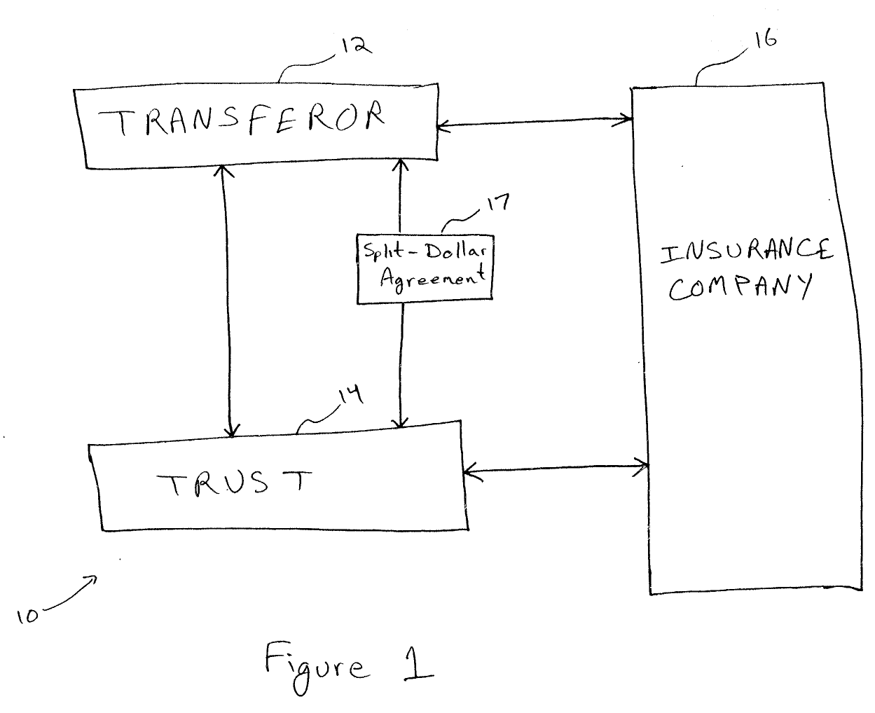

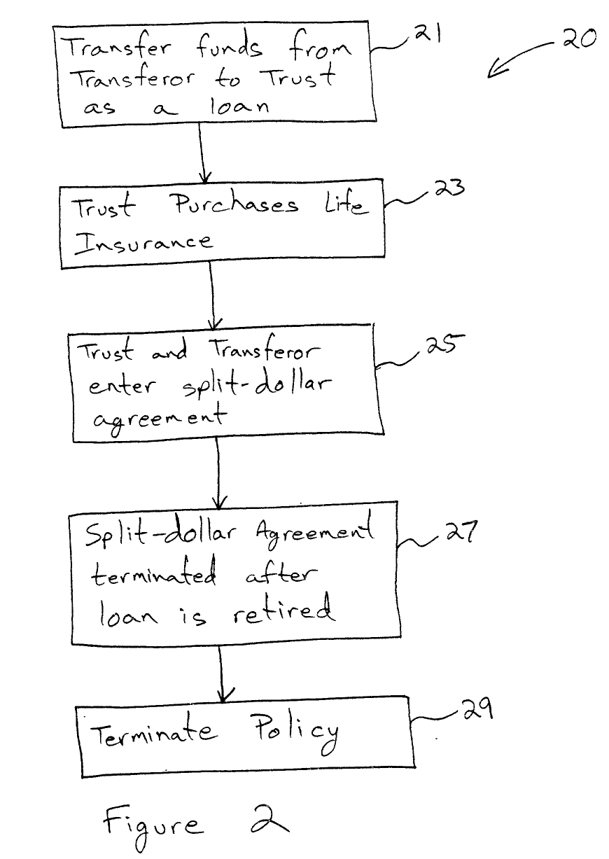

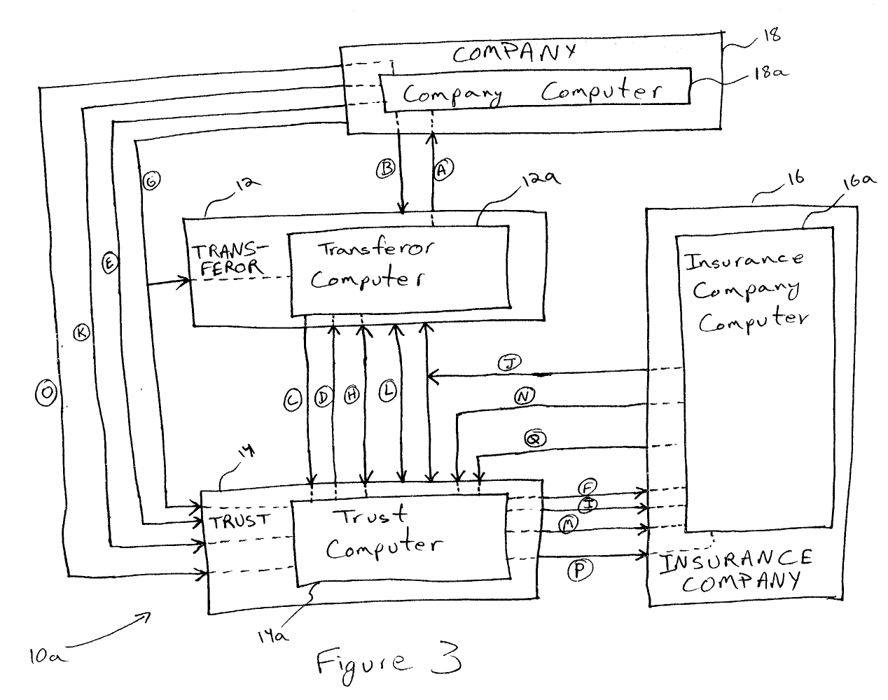

Referring now to the drawings, there is shown a plan 10 in FIG. 1 for transferring wealth in accordance with a preferred embodiment of the present invention. Further, FIGS. 2 and 3 illustrate a method 20 and a system 10a according to preferred embodiments of the invention for implementing the plan illustrated in FIG. 1.

Referring first to FIG. 1, the plan 10 includes a transferor 12 having a wealth to be transferred. The transferor 12 may be an individual or an entity such as a trust or a company subject to, for example, gift and estate taxes. The transferor 12 may be an individual intending to transfer wealth to his heirs or a corporation seeking to bestow a tax benefit upon an employee by reducing the tax liability. Further, the transferor 12, as illustrated in FIG. 3, may comprise a transferor computer 12a, for example, of a financial institution having an account containing the wealth to be transferred.

Referring again to FIG. 1, a trust 14 may be provided to which the wealth is to be transferred. The trust 14 may have one or more beneficiaries such as, for example, children, grandchildren or employees of the transferor 12. The trust 14 may be one of a variety of commonly available trusts. As illustrated in FIG. 3, the trust 14 may include a trust computer 14a for communicating with and transferring funds from and to other entities.

Referring again to FIG. 1, the plan 10 further includes the use of an insurance policy issued by, for example, an insurance company 16. The insurance policy may be a life insurance policy with a term component and a cash value component. Further details of the insurance policy are provided below with reference to FIGS. 2 and 3. As illustrated in FIG. 3, the insurance company 18 may also include an insurance company computer 16a capable of communicating and transferring funds with other entities.

Referring again to FIG. 1, ownership, responsibilities and benefits of the insurance policy may be governed by a split-dollar agreement 17 entered into by the transferor 12 and the trust 14 for at least a period of time. The split-dollar agreement 21 divides the benefits of the insurance policy by assigning the term benefits to one party and the cash value to the other party. The implementation of the split-dollar agreement is described below with reference to FIGS. 2 and 3.

The implementation of the wealth transfer plan illustrated in FIG. 1 may be accomplished according to the method 23 illustrated in FIG. 3 and the system 10a illustrated in FIG. 2. The plan is initiated by the transferor 12 by providing sufficient financial information to a plan administration company 18 having a company computer 18a, as illustrated by line A in FIG. 3, where the information may be transferred from the transferor computer 12a, such as by electronic mail, to the company computer 18a.

Referring now to FIG. 2, at block 21, a transfer of funds from the transferor 12 to the trust 14 may be initiated in the form of a loan. In this regard, FIG. 3 illustrates a message transmitted from the company computer 18a to the transferor 12 (line B) including instructions to transfer funds to the trust 14. A message including the fund transfer is then transmitted by the transferor computer 12a to the trust computer 14a (line C). The amount of the loan may be indicative of the amount of wealth to be transferred. In one example, the transferor 12 wishes to transfer $5 million of his wealth and loans that amount to the trust 14. In exchange for the loan, the trust 14 may transfer a note to the transferor 12. In this regard, a message may be transmitted from the trust computer 14a to the transferor computer 12a, as indicated by line D of FIG. 3.

At block 23 of FIG. 2, the company 18 causes the trust 12 to purchase a life insurance policy from the insurance company 16. In a system implementing an embodiment of the invention, as illustrated in FIG. 3, the company computer 18a may transmit a message to the trust 14 instructing the trust to purchase insurance, as indicated by line E. The company computer 18a may determine the amount of insurance to be purchased pursuant to the information previously gathered by line A. The trust computer 14a may then transmit a message, as indicated by line F, to the insurance company computer 16a to purchase the insurance policy. The message may also include a fund transfer to pay for an initial premium. Thus, the trust 14 is the owner of the policy.

It is understood that the purchase of the insurance policy may be initiated and completed prior to the transfer of loan funds from the transferor 12 to the trust 14.

The trust 14 may transfer regular premium payments for the insurance policy to the insurance company 16. Each premium payment may have a term portion and a cash value portion. For example, the policy may require a premium of $750,000 per year, of which $500,000 is the cost of the term portion.

At block 25 of FIG. 2, the company 18 causes the transferor 12 and the trust 14 to enter into a split-dollar agreement. In FIG. 3, this is illustrated by lines G and H. As indicated at line G, instruction messages may be sent from the company computer 18a to the respective computers 12a and 14a, whereby the trust 14 and the transferor 12 enter into a split-dollar agreement. Additional messages may be exchanged between the transferor computer 12a and the trust computer 14a, as indicated by line H. The trust computer 14a may also transmit a message to the insurance company computer 16a, notifying the insurance company 16 of the existence of the split-dollar agreement, as indicated by line I.

The split-dollar agreement assigns the death benefit of the policy to the transferor 12 and assigns the cash value to the trust 14. Thus, in lieu of principal payments on the note issued at line D, the trust 14 seeks to retire the loan with in-kind repayments in the form of term benefits (death benefits) from the insurance policy. Credit may, therefore, be applied toward the note for the value of the term benefit.

The term benefit may be valued according to an “economic benefit” assigned to it by the IRS in, for example, published Table PS58. For example, the “economic benefit” for the term portion of the policy may be $1 million per year according to Table PS58. Thus, the trust 14 would be required to assign the death benefits to the transferor 12 for a period of five years to retire a note of $5 million.

Accordingly, the insurance company computer 16a may transmit a message to the transferor computer 12a and the trust computer 14a, as indicated by line J of FIG. 3, notifying each of its assigned rights pursuant to the split-dollar agreement.

Once the complete amount of the note has been retired, the split-dollar agreement may be terminated, as indicated at block 27 of FIG. 2. In a system according to an embodiment of the invention as illustrated in FIG. 3, the company computer 18a may transmit a message to the trust computer 14a with instructions to terminate the split-dollar agreement, as indicated by line K. The trust computer 14a may then exchange messages with the transferor computer 12a to terminate the agreement (line L). The trust computer 14a may then transmit a message to the insurance company computer 16a, notifying the insurance company of the reversion of the death benefit to the trust (line M), followed by an acknowledgment message being transmitted from the insurance company computer 16a to the trust computer 14a (line N).

Once all rights in the insurance policy have reverted back to the trust 14, the trust 14 may choose to either maintain the policy or to cancel the policy, thereby obtaining any cash value in the policy. Factors such as the health and age of the insured may be taken into account in making this decision.

Referring again to FIG. 2, at a selected time, the company computer 18a may cause the trust 14 to terminate the insurance policy (block 29). In FIG. 3, the company computer 18a transmits a message to the trust computer 14a with instructions to terminate the insurance policy (line O). The trust computer 14a may then transmit a message to the insurance company computer 16a to terminate the policy, as indicated by line P in FIG. 3. The insurance company computer 16a may then transmit a message to the trust computer 14a (line Q). The message may include a fund transfer with any cash value in the cancelled insurance policy.

The complete amount of the loan may be retired after, for example, several years of term benefit assignment. This period may be accelerated by selecting a larger death benefit, resulting in a larger “economic benefit” according to Table PS58. One key to the successful implementation of the plan is the spread between the actual cost of the term portion (e.g., $500,000) and the Table PS58 “economic benefit” for the same term portion (e.g., $1 million). Thus, after five years, according to Table PS58, the loan of $5 million has been retired. However, of the original $5 million loan, the trust 14 may have only paid $3.75 million in premiums ($750,000 per year for five years). The trust may retain the difference of $1.25 million. Further, after five years, the policy may have a cash value of an additional $1.25 million, which reverts to the trust 14 when the policy is cancelled. Thus, $2.5 million of the $5 million loan (or 50%) has been successfully transferred to the trust 14. Greater percentages may be transferred if lower insurance costs can be achieved and the spread between the actual costs and the Table PS58 “economic benefit” can be increased.

It is to be understood that while various communications taking place between various computers may be conveniently accomplished via electronic mail, other forms of communication may also be employed, such as, for example, postal mail, telephone or other forms of communication.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

What is claimed is:

1. A method of transferring wealth, comprising:
causing a transferor to transfer cash to a transferee as a loan;
causing said transferee to purchase an insurance policy for a cost, said policy having a term portion, at least a portion of said cost being a cost of said term portion;
valuing said term portion at an economic benefit, said economic benefit being greater than said cost of said term portion;
causing said transferee to assign said term portion to said transferor for a period, said period being sufficiently large to accrue sufficient economic benefit to retire said loan.

2. The method according to claim 1, wherein said valuing is performed according to IRS Table PS58.

3. The method according to claim 1, further comprising:
terminating said insurance policy after said loan has been retired.

4. The method according to claim 1, further comprising:
reverting assignment of said term portion to said transferee after said loan has been retired.

5. The method according to claim 1, wherein said insurance policy has a cash portion, said cash portion being assigned to said transferee.

6. A system of transferring wealth, comprising:
means for causing a transferor to transfer cash to a transferee as a loan;
means for causing said transferee to purchase an insurance policy for a cost, said policy having a term portion, at least a portion of said cost being a cost of said term portion;
means for valuing said term portion at an economic benefit, said economic benefit being greater than said cost of said term portion;
means for causing said transferee to assign said term portion to said transferor for a period, said period being sufficiently large to accrue sufficient economic benefit to retire said loan.

7. The system according to claim 6, wherein said means for valuing values said term portion according to IRS Table PS58.

8. The system according to claim 6, further comprising:
means for terminating said insurance policy after said loan has been retired.

9. The system according to claim 6, further comprising:
means for reverting assignment of said term portion to said transferee after said loan has been retired.

10. The system according to claim 6, wherein said insurance policy has a cash portion, said cash portion being assigned to said transferee.

11. A program product, comprising machine readable program code for causing a machine to perform the following method steps:
causing a transferor to transfer cash to a transferee as a loan;
causing said transferee to purchase an insurance policy for a cost, said policy having a term portion, at least a portion of said cost being a cost of said term portion;
valuing said term portion at an economic benefit, said economic benefit being greater than said cost of said term portion;
causing said transferee to assign said term portion to said transferor for a period, said period being sufficiently large to accrue sufficient economic benefit to retire said loan.

12. A method of transferring wealth, comprising:
gathering information on the amount of wealth to be transferred;
determining an amount of cash to be transferred from a transferor to a transferee as a loan;
determining a term portion of an insurance policy to be purchased, said term portion having a cost; and
valuing said term portion at an economic benefit, said economic benefit being greater than said cost of said term portion.

13. The method according to claim 12, wherein said valuing is performed according to IRS Table PS58.
